(19) United States
(12) Patent Application Publication
(10) Pub. No.: US 2007/0100259 A1
(43) Pub. Date: May 3, 2007

(54) Massage apparatus

(75) Inventor: Simon Siu Man Nan, Richmond Hill (CA)

Correspondence Address: GREENSFELDER HEMKER & GALE PC, SUITE 2000, 10 SOUTH BROADWAY, ST LOUIS, MO, 63102, US

(73) Assignee: NANMA MANUFACTURING CO. LTD., Chai Wan (HK)

(21) Appl. No.: 11/264,995

(22) Filed: Nov. 2, 2005

(51) Int. Cl. A61H 7/00

(52) U.S. Cl. 601/7; 601/46

(57) ABSTRACT

A massage apparatus for providing a varied non-periodic pulsed vacuum effect is disclosed. The massage apparatus may include a body including a hollow handle engaged to a swivel head by a flexible member that permits the swivel head to be bent at various orientations relative to the handle and retain that bent orientation. The massage apparatus further includes a vibratory component for providing a vibrating function and a vacuum pulsation generator that generates the varied non-periodic pulsed vacuum effect.

### FIELD

The present document relates to a massage apparatus, and more particularly to a massage apparatus that produces a vacuum.

### SUMMARY

In one embodiment, the massage apparatus comprises a body having a handle engaged to a vibratory casing, the handle including a vacuum pulsation generator disposed therein, the vacuum pulsation generator for generating a vacuum effect and having a means for automatically generating a varied pulsed vacuum effect, and a suction cup engaged to the vibratory casing for producing a varied pulsed vacuum and/or vibrating effect.

In another embodiment, the massage apparatus comprises a handle having a vacuum pulsation generator disposed therein, the vacuum pulsation generator in operative association with a conduit, the vacuum pulsation generator providing a means for generating a varied pulsed vacuum effect through the conduit,

a vibrator casing operatively associated with the handle through a flexible member forming the conduit, the vibrator casing having a vibratory component disposed therein for providing a vibrating function, and a swivel head operatively engaged to the vibratory casing through the flexible member, the flexible member being capable of retaining a bent orientation relative to the handle.

In yet another embodiment, the vacuum pulsation generator comprises an upper casing and a lower casing collectively defining a main chamber having a motor operatively disposed therein, the upper casing defining an inlet in selective fluid flow communication with an air-intake check valve operable between open and closed positions for permitting or preventing fluid flow communication through the inlet, the upper casing further defining an outlet in selective fluid flow communication with an air-exhaust check valve operable between an open and closed positions for permitting or preventing fluid flow communication through the outlet, the motor being operatively associated with a flexible diaphragm through a movable link driven by operation of the motor.

In another embodiment, the massage apparatus comprises a body having a conduit in fluid flow communication with a vacuum pulsation generator disposed inside the body, the vacuum pulsation generator being adapted to generate a varied pulsed vacuum effect through the conduit.

Implementation of the above embodiments may include one or more of the following features:

The vibrator casing is engaged to the handle through a flexible member, the vibrator casing including a vibratory component disposed therein for providing a vibratory effect.

The flexible member permits the suction cup to be positioned in various orientations relative to the hollow body and retain that bent orientation.

The vacuum pulsation generator comprises upper and lower casings defining a main chamber.

The vacuum pulsation generator comprises a flexible diaphragm operatively disposed inside the main chamber, the diaphragm being operable to that generate the varied pulsed vacuum effect by varying volume above the diaphragm on the main chamber.

The vacuum pulsation generator further comprises an air-intake check valve in selective fluid flow communication with the main chamber for preventing or permitting fluid flow in communication with the main chamber.

The air-intake check valve is in operative engagement with a control switch, the control switch having a means for automatically providing a varied pulsed vacuum effect.

The air-exhaust check valve is in operative engagement with a vacuum release button, the vacuum release button providing a means for releasing vacuum from the main chamber when the air-exhaust check valve is in the open position.

The vacuum pulsation generator further comprises a diaphragm-pushing holder operatively engaged to the diaphragm and defining a fixed pivot, the diaphragm-pushing holder being operatively engaged to a movable link, wherein movement of the movable link causes the diaphragm-pushing holder to move the diaphragm in a reciprocating movement for producing a varied pulsed vacuum effect.

The movable link is operatively engaged to a shaft of a motor, the shaft defining a moving pivot, wherein movement of the moving pivot relative to the fixed pivot by the movable link when the motor is operable causes the diaphragm-pushing holder to move the diaphragm in the reciprocating movement.

The moving pivot is eccentrically mounted to the shaft.

The diaphragm has a peripheral area operatively engaged to a support spring.

The suction cup is in fluid flow communication with the vacuum pulsation generator through a conduit for providing the varied pulsed vacuum effect.

The vacuum pulsation generator further comprises a control switch for providing a vacuum mode for generating a vacuum in the vacuum environment.

The vacuum pulsation generator further comprises a vacuum release button operable to release vacuum from the main chamber.

Additional features will be set forth in the description which follows or will become apparent to those skilled in the art upon examination of the drawings and detailed description which follows.

### BRIEF DESCRIPTION OF THE DRAWINGS

FIG. 1 is a perspective view of the massage apparatus;

FIG. 2 is an exploded view of the massage apparatus;

FIG. 3 is a simplified cross-sectional illustration of the vacuum pulsation generator of the massage apparatus;

FIGS. 4A and 4B are partial cross-sectional views of the suction cup assembly of the massage apparatus;

FIGS. 5A and 5B are simplified cross-sectional illustrations of the vacuum pulsation generator showing the airflow pathway during vacuum generating process;

FIG. 6 is a simplified cross-sectional illustration of the vacuum pulsation generator showing the process of producing an automatic and varied pulsed vacuum effect; and

FIG. 7 is a simplified cross-sectional illustration of the vacuum pulsation generator showing the process of vacuum release.

Corresponding reference characters indicate corresponding elements among the view of the drawings.

### DETAILED DESCRIPTION

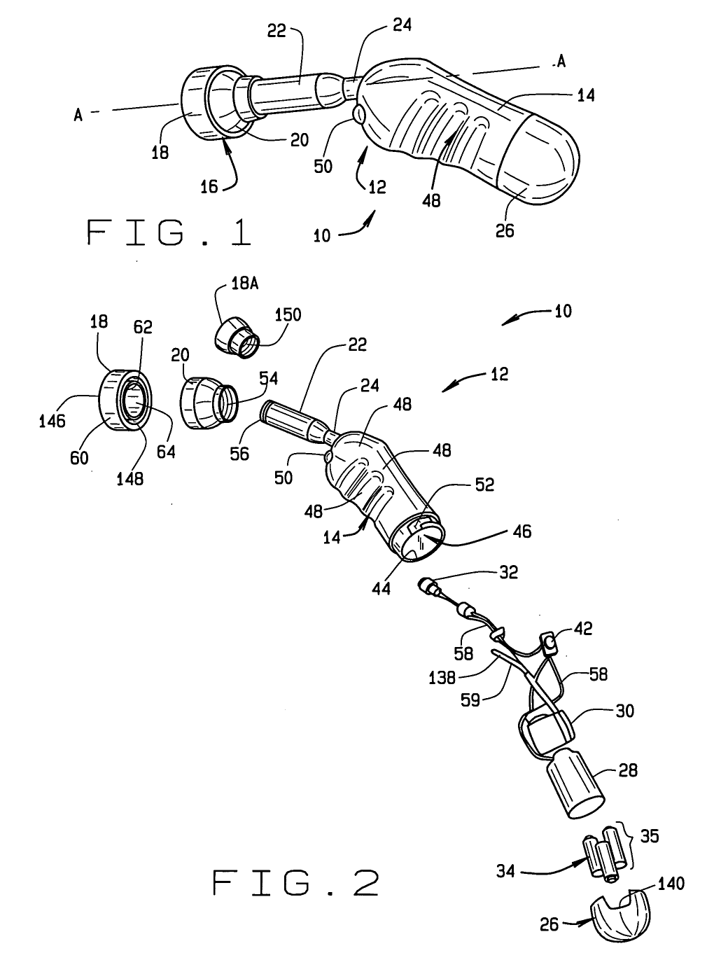

Referring to the drawings, an embodiment of the massage apparatus is illustrated and generally indicated as 10 in FIG. 1. The massage apparatus 10 may include a body 12 including a hollow handle 14 engaged to a swivel head 16 by a flexible member 24 that permits the swivel head 16 to be bent at various orientations relative to the handle 14 and retain that bent orientation after the bending force has been removed.

In one embodiment, the swivel head 16 may be made of a resilient material and has a generally cylindrical shape with a double-layered construction comprising a flexible suction cup 18 engaged to a support cup 20. Referring to FIGS. 1 and 2, the support cup 20 defines internal threads 54 adapted to engage external threads 56 defined by a vibrator casing 22 which houses a vibratory component 32 that provides a means for producing a vibratory effect as shall be discussed in greater detail below.

As further shown, the handle 14 defines a chamber 46 that communicates with an open end 44 and is adapted to house a vacuum pulsation generator 30 therein for providing an automatic and varied pulsed vacuum effect. The chamber 46 also houses a battery source 34 comprising a plurality of batteries 35 encased in a battery casing 28 that provide a power supply to the various components of the massage apparatus 10, such as the vibratory component 32 and vacuum pulsation generator 30 through a wire 58. In addition, wire 58 may also be adapted to transmit signals that control operation of various components of massage apparatus 10. An end cap 26 may define at least one protrusion 140 adapted to engage at least one L-shaped slot 52 defined around the periphery of open end 44 of handle 14 in order to secure the end cap 26 to handle 14. A plurality of extruded profiles 48 may be defined along the exterior of handle 14 for providing an ergonomic and comfortable gripping surface for the user. The handle 14 may further comprise a vacuum release button 50 that is operatively associated with vacuum pulsation generator 30 for controlling vacuum release operation of the massage apparatus 10.

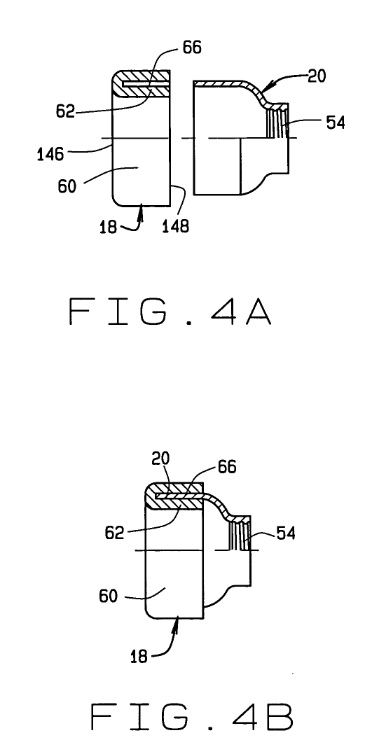

In one embodiment shown in FIGS. 2, 4A and 4B, swivel head 16 may include a suction cup 18 having an outer portion 60 and an inner portion 62 with a channel 66 defined between portions 60 and 62. Inner portion 62 defines a bore 64 that communicates with a distal opening 146 and an opposing proximal opening 148. The suction cup 18 may be engageable with support cup 20 such that support cup 20 engages the channel 66 of suction cup 18. In another embodiment shown in FIG. 2, suction cup 18A may define a smooth bore 150 with no inner portion that is adapted to engage vibratory casing 22. However, it is contemplated that any suction cup 18 configured to apply a pulsed vacuum and/or vibratory effect to the user is felt to fall within the scope of the present embodiment.

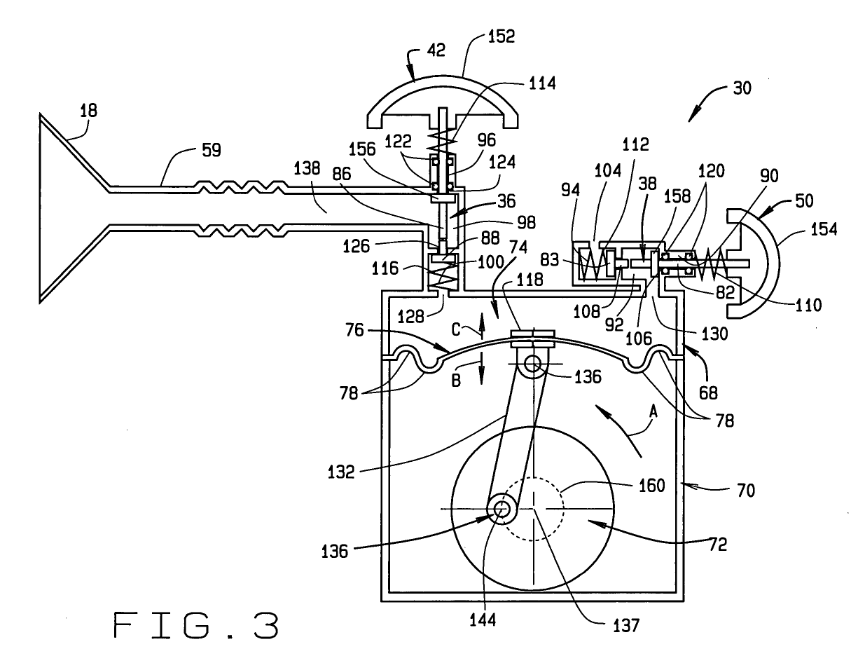

Referring to FIG. 3, the vacuum pulsation generator 30 may be adapted to provide an automatic means of generating a varied pulsed vacuum effect by massage apparatus 10 such that the vacuum generated is provided in varied, non-periodic pulses. Specifically, the vacuum pulsation generator 30 may include an upper casing 68 engaged to a lower casing 70 for housing the various components of the vacuum pulsation generator 30. Further, the vacuum pulsation generator 30 may include a control switch 42 operatively engaged to an air-intake valve 36 that is in selective fluid flow communication with a main chamber 74 defined by upper casing 68 and a flexible diaphragm 76. The vacuum pulsation generator 30 may further include a vacuum release button 50 that is operatively engaged with an air-exhaust check valve 38 that permits air to be evacuated from main chamber 74 when vacuum is released as shall be described in greater detail below.

As further shown, the air-intake check valve 36 may include a first chamber 98 in communication with a second chamber 100 through a port 126 at one end and a conduit 138 at another end, while second chamber 100 may be in fluid flow communication with main chamber 74 through an inlet 128. The air-intake check valve 36 may further include a rod 86 that is operatively associated with control switch 42 for controlling the operation of air-intake check valve 36. The rod 86 is slidably disposed through channel 96 and includes a stop 156 that is engageable with the wall of chamber 98 along opening 124 for controlling the lateral movement of rod 86. Rod 86 is operatively engageable with a plug 88 that is adapted to selectively permit or prevent fluid flow communication through port 126 of air-intake check valve 36. As further shown, control switch 42 may include a spring 114 operatively engaged to rod 86 at one end, while a spring 116 is operatively engaged to plug 88. Spring 116 applies a bias to the plug 88 and spring 114 applies a counter bias against handle 154 by rod 86 such that control switch 42 is operatively associated with plug 88 for selectively permitting or preventing fluid flow communication through opening 126 upon actuation of switch 42. A pair of sealing elements 122 made of a resilient material is disposed around channel 96 for providing a fluid tight seal around rod 86.

The air-exhaust check valve 38 may include a first chamber 92 in communication with a second chamber 94 through an opening 108 and the main chamber 74 through an outlet 130. In addition, vacuum release button 50 may include a handle 154 operatively engaged to a rod 82 that communicates with first chamber 92 through a channel 90. The rod 82 may be operatively associated with a stop 158 that is engageable with the wall of chamber 92 along opening 106 for controlling the lateral movement of rod 82. Rod 82 may be operatively engageable with a plug 83 that is adapted to selectively permit or prevent fluid flow communication through opening 108 when actuated by the vacuum release button 50. As further shown, second chamber 94 defines a port 104 in fluid flow communication with atmosphere for permitting bi-directional airflow from the main chamber 74. Vacuum release button 50 may include a first spring 110 operatively associated with rod 82 at one end, while a second spring 112 is operatively engaged to plug 83. Spring 112 applies a spring bias to the plug 83 and spring 110 applies a counter spring bias against handle 154 by rod 82 such that the vacuum release button 50 is operatively associated with plug 83 for selectively permitting or preventing fluid flow communication through opening 108 upon actuation of button 50. Finally, first and second sealing elements 120 may be disposed around channel 90 for providing a fluid-tight seal around rod 82.

As further shown, flexible diaphragm 76 may be engaged along its peripheral area to a support spring 78 mounted between the upper and lower casings 68, 70 of the vacuum pulsation generator 30 for facilitating a reciprocating movement by diaphragm 76. The flexible diaphragm 76 is operatively engaged to a movable link 132 through a diaphragm-pushing holder 118 that provides a means for transmitting a force to flexible diaphragm 76 that causes diaphragm 76 to move in a reciprocating movement such that a varied pulsed vacuum effect is provided when actuated by the user. This varied pulsed vacuum effect produced by the vacuum pulsation generator 30 automatically generates pulses of vacuum in a varied, non-periodic manner through a conduit 138 that is defined through tubing 59 and in selective fluid flow communication between the suction cup 18 and the vacuum pulsation generator 30.

To provide this varied pulsed vacuum effect, the movable link 132, for example a flexible belt, may be operatively engaged to the diaphragm-pushing holder 118 at one end and a moving pivot 136 at the opposite end thereof. In addition, the movable link 132 may be operatively engaged to a motor 72 and transmits a force generated by the rotation of moving pivot 136 by motor shaft 144 about a fixed point 137 relative to a fixed pivot 136 defined by the diaphragm-pushing holder 118. The rotating action of the moving pivot 136 about fixed point 137 along pathway 160 transmits a generally reciprocating force to the diaphragm- pushing holder 118 that causes the flexible diaphragm 76 to move in a reciprocating movement illustrated by directions B and C. The movable link 132 may be eccentrically mounted to the motor shaft 144 for generating this reciprocating movement for producing varied, non-periodic pulses of vacuum.

As noted above, the control switch 42 may control the operation of the massage apparatus 10 in one of three modes; OFF mode; VACUUM mode; and VIBRATION mode by moving the switch 42 in one of three positions that correspond to each respective mode. When the control switch 42 is placed in the VACUUM mode, a continuous vacuum is then generated that draws air into the vacuum pulsation generator 30 from the suction cup 18 and through conduit 138. If it is desired to release vacuum, the user may actuate the vacuum release button 50 as discussed below. When the control switch 42 is placed in the VIBRATION mode, the vibratory component 32 is activated which causes the vibratory component 32 to generate a vibration movement in a direction perpendicular to the axis of the component 32. This vibration movement causes the entire swivel head 16 to vibrate while vacuum may be simultaneously generated by massage apparatus 10 and applied by suction cup 18.

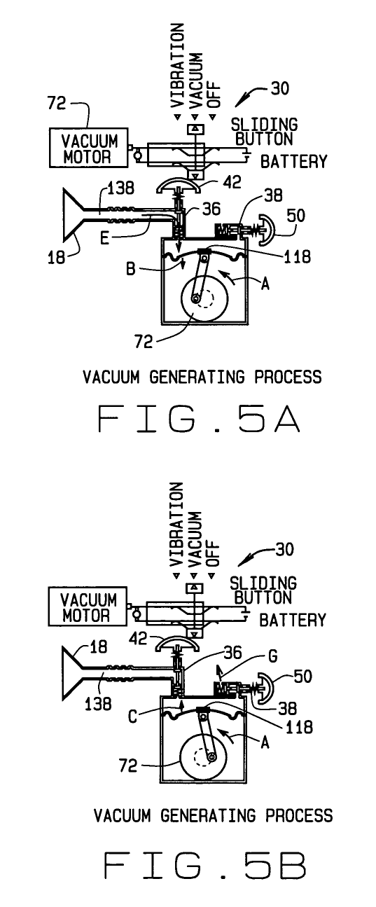

As illustrated in FIG. 5A, when the control switch 42 is placed from the OFF mode to the VACUUM mode, the vacuum pulsation generator 30 is activated in order to generate a level of sufficient vacuum within massage apparatus 10. During this vacuum generating process, the air-intake check valve 36 may be placed in the open position when handle 152 is actuated and overcomes the spring bias applied by spring 116. This action disengages the plug 88 from opening 126 to permit fluid flow communication through inlet 128 as indicated by airflow E. At the same time, the air-exhaust check valve 38 is in the closed position for preventing fluid flow communication through outlet 130. As the motor 72 rotates the motor shaft 144 in a counter clockwise direction A the flexible diaphragm 76 initially moves in direction B such that airflow E from conduit 138 enters the portion of main chamber 74 above diaphragm 76 through inlet 128.

Referring to FIG. 5B, should the proximal opening 146 of suction cup 18 become blocked, continual rotation of motor shaft 144 in direction A while the air-intake check valve 36 is in the closed position and the air-exhaust check valve 38 is in the open position causes diaphragm 76 to then move in a direction C such that airflow G is permitted to exit from air-exhaust check valve 138 through outlet 130 and port 104.

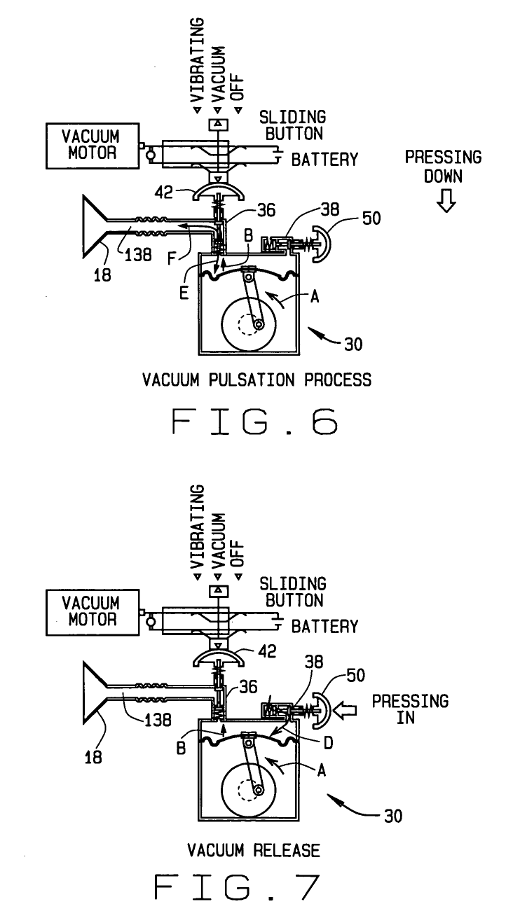

Referring to FIG. 6, when sufficient vacuum has been generated to a certain level by the vacuum pulsation generator 30, the user may actuate control switch 42 to the VIBRATION mode that causes the massage apparatus 10 to provide both the varied pulsed vacuum and vibration effects. In addition, actuating the control switch 42 to the VIBRATION mode causes rod 86 to engage plug 88 that permits fluid flow communication through opening 126 and causes the air-intake check valve 36 to be placed in the open position such that the vacuum level inside main chamber 74 is not increased, but maintained at that certain vacuum level. Because the motor 72 remains in operation such that diaphragm 76 moves in a reciprocating movement, the volume of space of chamber 74 above the diaphragm 76 is made to vary when the diaphragm 76 is moved between directions B and C. This variation in the volume of main chamber 74 above diaphragm 76 automatically produces the varied pulsed vacuum effect in the vacuum environment.

Referring to FIG. 7, when the user presses vacuum release button 50 while the control switch 42 remains in the VIBRATION mode, rod 82 is brought into engagement with plug 83 that permits fluid flow communication through port 104 and release the vacuum generated in main chamber 74, thereby terminating the varied pulsed vacuum effect in the vacuum environment.

It should be understood from the foregoing that, while particular embodiments have been illustrated and described, various modifications can be made thereto without departing from the spirit and scope of the invention as will be apparent to those skilled in the art. Such changes and modifications are within the scope and teaching of this invention as defined in the claims appended hereto.

What is claimed is:

1. A massage apparatus comprising:
a body having a handle engaged to a vibratory casing, the handle including a vacuum pulsation generator disposed therein, said vacuum pulsation generator for generating a vacuum effect and having a means for automatically generating a varied pulsed vacuum effect, and
a suction cup engaged to said vibratory casing for applying a varied pulsed vacuum and/or vibrating effect.

2. The massage apparatus according to claim 1, wherein said vibrator casing is engaged to said handle through a flexible member, said vibrator casing including a vibratory component disposed therein for providing a vibratory effect.

3. The massage apparatus according to claim 2, wherein said flexible member permits said suction cup to be positioned in various orientations relative to said hollow body and retain that bent orientation.

4. The massage apparatus according to claim 1, wherein said vacuum pulsation generator comprises upper and lower casings defining a main chamber.

5. The massage apparatus according to claim 4, wherein said vacuum pulsation generator comprises a flexible diaphragm operatively disposed inside said main chamber, said diaphragm being operable to that generate said. varied pulsed vacuum effect by varying volume above the diaphragm on said main chamber.

6. The massage apparatus according to claim 5, wherein said vacuum pulsation generator further comprises an air-intake check valve in selective fluid flow communication with said main chamber for preventing or permitting fluid flow in communication with said main chamber.

7. The massage apparatus according to claim 6, wherein said air-intake check valve is in operative engagement with a control switch, said control switch having a means for automatically providing a varied pulsed vacuum effect.

8. The massage apparatus according to claim 6, wherein said air-exhaust check valve is in operative engagement with a vacuum release button, said vacuum release button providing a means for releasing vacuum from said main chamber when said air-exhaust check valve is in the open position.

9. The massage apparatus according to claim 5, wherein said vacuum pulsation generator further comprises a diaphragm-pushing holder operatively engaged to said diaphragm and defining a fixed pivot, said diaphragm-pushing holder being operatively engaged to a movable link, wherein movement of the movable link causes said diaphragm-pushing holder to move said diaphragm in a reciprocating movement for producing a varied pulsed vacuum effect.

10. The massage apparatus according to claim 9, wherein said movable link is operatively engaged to a shaft of a motor, said shaft defining a moving pivot, wherein movement of the moving pivot relative to the fixed pivot by the movable link when said motor is operable causes said diaphragm-pushing holder to move said diaphragm in said reciprocating movement.

11. The massage apparatus according to claim 10, wherein said moving pivot is eccentrically mounted to said shaft.

12. The massage apparatus according to claim 5, wherein said diaphragm has a peripheral area operatively engaged to a support spring.

13. The massage apparatus according to claim 1, wherein said suction cup is in fluid flow communication with said vacuum pulsation generator through a conduit for providing said varied pulsed vacuum effect.

14. The massage apparatus according to claim 2, wherein said vacuum pulsation generator further comprises a control switch for providing a vacuum mode for generating a vacuum in the vacuum environment.

15. The massage apparatus according to claim 1, wherein said vacuum pulsation generator further comprises a vacuum release button operable to release vacuum from said main chamber.

16. A massage apparatus comprising:
a handle having a vacuum pulsation generator disposed therein, said vacuum pulsation generator in operative association with a conduit, said vacuum pulsation generator providing a means for generating an automatic and varied pulsed vacuum effect through said conduit,
a vibrator casing operatively associated with said handle through a flexible member forming a conduit, said vibrator casing having a vibratory component disposed therein for providing a vibrating function, and
a swivel head operatively engaged to said vibratory casing through said flexible member, said flexible member being capable of retaining a bent orientation relative to said handle.

17. A vacuum pulsation generator comprising:
an upper casing and a lower casing collectively defining a main chamber having a motor operatively disposed therein, said upper casing defining an inlet in selective fluid flow communication with an air-intake check valve operable between open and closed positions for permitting or preventing fluid flow communication through said inlet, said upper casing further defining an outlet in selective fluid flow communication with an air-exhaust check valve operable between an open and closed positions for permitting or preventing fluid flow communication through said outlet, said motor being operatively associated with a flexible diaphragm through a movable link driven by operation of said motor.

18. The vacuum pulsation generator according to claim 17, wherein operation of said motor generates a vacuum when said air-intake check valve is in an open position and said air-exhaust check valve is in the closed position.

19. The vacuum pulsation generator according to claim 17, wherein when said air-intake check valve is in the open position and the air-exhaust check valve is in the open position a varied pulsed vacuum effect is automatically produced.

20. The vacuum pulsation generator according to claim 17, wherein said air-exhaust check valve is in operative engagement with a vacuum release button, said vacuum release button providing a means for releasing vacuum through air-exhaust check valve.

21. The vacuum pulsation generator according to claim 17, wherein said pulsation vacuum generator further comprises a diaphragm-pushing holder operatively engaged to said flexible diaphragm, said diaphragm-pushing holder being operatively engaged to said movable link for moving said flexible diaphragm in a reciprocating movement for generating said varied pulsed vacuum effect.

22. The vacuum pulsation generator according to claim 17, wherein said movable link is operatively engaged to said motor through a motor shaft, said motor shaft defining a moving pivot and said diaphragm-pushing holder defining a fixed pivot, such that movement of the moving pivot relative to the fixed pivot by movement of said movable link causes said diaphragm-pushing holder to move said flexible diaphragm in a reciprocating movement.

23. The vacuum pulsation generator according to claim 17, wherein said flexible diaphragm is operatively engaged to a support spring.

24. A massage apparatus comprising:
a body having a conduit in fluid flow communication with a vacuum pulsation generator disposed inside the body, the vacuum pulsation generator being adapted to generate a varied pulsed vacuum effect through the conduit.

25. The massage apparatus according to claim 24, wherein said vacuum pulsation generator comprises a flexible diaphragm for producing said varied pulsed vacuum effect.

26. The massage apparatus according to claim 25, wherein said flexible diaphragm is operatively engaged to a diaphragm-holding member for producing a reciprocating movement in the flexible diaphragm.
